(19) United States
(12) Patent Application Publication
(10) Pub. No.: US 2023/0148640 A1
(43) Pub. Date: May 18, 2023

(54) TOFU PRODUCTION SYSTEM

(71) Applicant: TAKAI TOFU & SOYMILK EQUIPMENT CO., Ishikawa (JP)

(72) Inventors: Toichiro TAKAI, Ishikawa (JP); Motonari AMANO, Ishikawa (JP); Yusuke SETO, Ishikawa (JP)

(73) Assignee: TAKAI TOFU & SOYMILK EQUIPMENT CO., Ishikawa (JP)

(21) Appl. No.: 17/906,949

(22) PCT Filed: Apr. 30, 2021
(86) PCT No.: PCT/JP2021/017305

§ 371 Date: Sep. 21, 2022

(30) Foreign Application Priority Data
Apr. 30, 2020 (JP) 2020-080297
Nov. 18, 2020 (JP) 2020-191602

(51) Int. Cl. A23L 11/45; B07C 5/342; G06T 7/00

(52) U.S. Cl. CPC A23L 11/45; B07C 5/342; G06T 7/001; B07C 2501/0063; B07C 2501/0081; G06T 2207/20084; G06T 2207/30128

(57) ABSTRACT

A tofu production system includes: a production device configured to continuously produce tofu; a conveyance device configured to arrange the tofu produced by the production device according to a predetermined rule corresponding to the tofu and convey the tofu; a tofu inspection device configured to inspect the tofu on the conveyance device; and a sorting and removing device configured to sort or remove a defective product in the tofu being conveyed by the conveyance device based on an inspection result of the tofu inspection device.

### TECHNICAL FIELD

The present invention relates to a tofu production system.

### BACKGROUND ART

According to related art, an inspection operation of detecting a non-defective product or a defective product among products in a production line and removing a product determined as the defective product from shipping objects has been performed as quality control on the products. Even at present when automation of production lines for products progresses, such an inspection operation often relies on human experience and visual observation, resulting in heavy human burden. On the other hand, tofu, which is an example of a product, is required to have a low unit price and a high production capacity per predetermined time from a viewpoint of cost reduction.

Regarding automation of a production line of such a product, various methods have been disclosed in order to improve the production capacity. Patent Literature 1 discloses a technique of applying a method of deep learning and multivariate analysis by artificial intelligence (AI) in order to automatically sort a non-defective product or a defective product of food.

### CITATION LIST

### Patent Literature

Patent Literature 1: JP-A-2019-211288

### SUMMARY OF INVENTION

### Technical Problem

For example, it is assumed that a subtle change occurs in tofu, fried tofu, or the like depending on a production situation, a quality of a raw material, or the like. In addition, it is necessary to timely vary a determination criterion for determining the non-defective product or the defective product according to production conditions such as the number of products required for production or a disposal rate. According to the related art, such a determination is made by humans, and the determination criterion is also adjusted according to human experience or the like. Therefore, work by humans is required, and a workload is heavy. In the prior art described above, the tofu cannot be inspected from a viewpoint of characteristics of the tofu during production, and a load of manual inspection cannot be reduced. In addition, in order to improve productivity, there is room for improvement in conveyance control and handling of the non-defective product/defective product during inspection of the tofu and according to an inspection result. Further, in order to install a production system in a limited space, there is also a demand to make a size of the entire production system compact.

In view of the above problems, an object of the present invention is to improve a production capacity while reducing a manual load during production of tofu.

### Solution to Problem

In order to solve the above problems, the present invention has the following configuration. That is, a tofu production system includes: a production device configured to continuously produce tofu; a conveyance device configured to arrange the tofu produced by the production device according to a predetermined rule corresponding to the tofu and convey the tofu; a tofu inspection device configured to inspect the tofu on the conveyance device; and a sorting and removing device configured to sort or remove a defective product in the tofu being conveyed by the conveyance device based on an inspection result of the tofu inspection device.

### Advantageous Effects of Invention

According to the present invention, it is possible to improve a production capacity while reducing a manual load during production of tofu.

### BRIEF DESCRIPTION OF DRAWINGS

FIG. 1 is a schematic configuration view showing an example of an overall configuration of a tofu production system according to a first embodiment.

FIG. 2 is a schematic view showing operations of an inspection device and a sorting and removing device according to the first embodiment.

FIG. 3 is a block diagram showing an example of a functional configuration of a control device according to the first embodiment.

FIG. 4 is a conceptual diagram showing an overview of learning processing according to the first embodiment.

FIG. 5 is a flowchart of processing by the control device according to the first embodiment.

FIG. 6 is a schematic configuration view showing an example of an overall configuration of a tofu production system according to a second embodiment.

FIG. 7 is a schematic view showing an operation of a sorting and removing device according to the second embodiment.

### DESCRIPTION OF EMBODIMENTS

Hereinafter, embodiments of the present invention will be described with reference to the drawings. The embodiments described below are embodiments for explaining the present invention, and are not intended to be interpreted as limiting the present invention. Moreover, not all configurations described in each embodiment are essential configurations for solving the problems of the present invention. In the drawings, the same components are denoted by the same reference numerals to indicate correspondence.

### First Embodiment

Hereinafter, a first embodiment of the present invention will be described.

First, characteristics of tofu as a product to be inspected according to the present invention during production will be described. The tofu has characteristics that a shape and an appearance of the product easily varies due to influence of raw materials, a production environment, and the like. For example, an appearance of fried tofu, which is a kind of tofu, may vary depending on a degree of expansion of an intermediate product, a degree of progress of deterioration of frying oil, or the like. Since the tofu is also affected by the production environment, the shape and appearance of the product may vary depending on a production place, a daily environmental change, a state of a production machine, and the like. That is, the tofu may have various shapes and appearances as compared with industrial products such as electronic devices.

When the tofu product is manually inspected, a quality determination criterion is finely adjusted based on experience or the like in consideration of production conditions (the number of products required for production, a disposal rate, and the like) on the day. That is, the criterion for determining a quality of the tofu may need to vary depending on a producer, a production timing, and the like. Further, the tofu may be produced in consideration of regional characteristics, a taste of the producer or a purchaser, and the like, and the quality determination criterion may be diverse from such a viewpoint. While it is necessary to perform an inspection in consideration of the characteristics of the tofu, the tofu is required to have a low unit price and a high production capacity per predetermined time from a viewpoint of cost reduction.

A tofu production system in consideration of the characteristics of tofu during production as described above will be described in the first embodiment of the present invention.

[Configuration Overview]

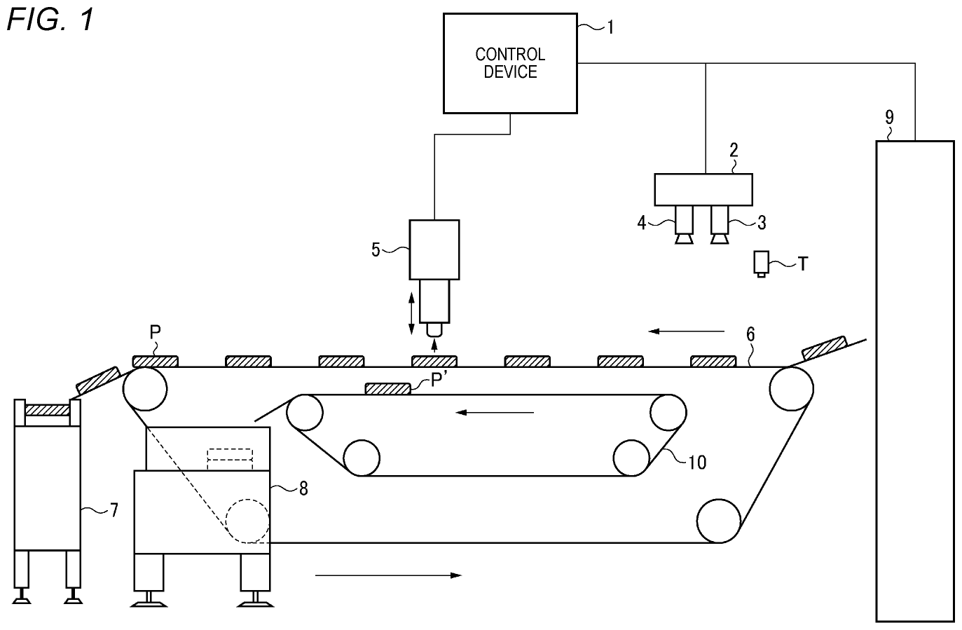

FIG. 1 is a schematic configuration view showing an overall configuration of a tofu production system (hereinafter, simply referred to as a “production system”) according to the present embodiment. The production system includes a control device 1, an inspection device 2, a sorting and removing device 5, a first conveyance device 6, a second conveyance device 7, a storage device 8, a production device 9, and a defective product conveyance device 10. Here, a product is collectively described as “tofu”, but more detailed classification included therein is not particularly limited. Examples of the tofu may include deep-fried tofu, a deep-fried tofu pouch, thin deep-fried tofu, thick deep-fried tofu, a tofu cutlet, and a deep-fried tofu burger. Examples of the tofu may further include packaged silken tofu, silken tofu, cotton tofu, grilled tofu, and dried-frozen tofu. In addition, examples of the tofu may include an intermediate product of the above tofu, a product before or after packaging, or a product before or after cooling, freezing, or heating. In the following description, for the product (tofu), a product determined to have a certain quality or higher (that is, a non-defective product) is indicated by P, and a product determined to have a quality lower than the certain quality (that is, a defective product) is indicated by P′. When the product is comprehensively described, the reference numerals will be omitted.

The control device 1 controls an image capturing operation of the inspection device 2. The control device 1 also controls an operation of the sorting and removing device 5 based on an image acquired by the inspection device 2. The inspection device 2 includes an image capturing unit 3 and an irradiation unit 4. The image capturing unit 3 includes a charge coupled device (CCD) camera, a complementary metal-oxide-semiconductor (CMOS) camera, or the like. Further, a detection sensor T (for example, a reflective laser sensor or the like) that detects a product being conveyed by the first conveyance device 6 is provided. The inspection device 2 captures an image at an appropriate timing based on a signal from the detection sensor T and a predetermined waiting time defined according to a conveyance speed of the first conveyance device 6. The irradiation unit 4 irradiates the first conveyance device 6 (that is, a product to be inspected) with light in order to acquire a more appropriate image at the time of capturing an image by the image capturing unit 3. The image capturing operation of the inspection device 2 may be performed based on an instruction from the control device 1 in addition to the signal from the detection sensor T. A position of the sorting and removing device 5 is controlled based on an instruction from the control device 1, and the sorting and removing device 5 takes out the product P′ specified as a defective product from products being conveyed by the first conveyance device 6, conveys the product P′ to the defective product conveyance device 10, and stores the product P′ in the storage device 8. An operation of the sorting and removing device 5 may be performed for a purpose of selecting and sorting products of various qualities specified by characteristics, product types, applications, or the like, in addition to a purpose of removing defective products. The sorting and removing device 5 may be shared in order to perform sorting and removal based on inspection results of other inspection devices such as an image inspection device, an X-ray detector, a metal detector, and a weight inspection device connected to the same line as the first conveyance device and the second conveyance device. These inspection results may also be appropriately combined to perform partial, composite, or comprehensive determination, whereby sorting/removal may be performed.

FIG. 1 shows an example in which the sorting and removing device 5 includes a linear motion cylinder (not shown) and a grip portion. By extension and contraction of the linear motion cylinder in an upper-lower direction (Z axis), the grip portion is adjusted to a height at which the product P′ determined as the defective product can be gripped. The linear motion cylinder is, for example, a linear motion actuator system using a rack and pinion mechanism or a ball screw mechanism by a servo motor or a stepping motor, and may include an air cylinder or a hydraulic cylinder with a scale mechanism. The linear motion cylinder horizontally moves the grip portion in an X-axis direction and/or a Y-axis direction, which are directions/is a direction perpendicular to the Z-axis direction. The grip portion of the sorting and removing device 5 may include hand-shaped gripping means including a plurality of finger portions, holding means such as a vacuum suction pad type or a swirling airflow suction type, or the like. Since the sorting and removing device 5, the inspection device 2, and the like according to the present embodiment handle food such as tofu, it is desirable that each has a certain quality according to, for example, an ingress protection standard (IP standard), which is a waterproof/dustproof standard for electronic devices. Specifically, a waterproof/dustproof grade having an IP standard of 54 or higher is preferable, and an IP of 65 or higher is more preferable.

The first conveyance device 6 conveys a plurality of products in a predetermined conveyance direction. The products may be conveyed in one row or may be conveyed while being arranged in a plurality of rows. In the present embodiment, a configuration in which the products are conveyed while being arranged in a plurality of rows will be described. It is preferable that the products are arranged in a matrix or in a staggered manner, but the products may be randomly conveyed in a non-overlapping state. A size of the tofu as a product varies depending on the product. Therefore, the number of rows and arrangement during conveyance may be defined according to a relationship between a width of the first conveyance device 6 and the size of the product. Further, the number of rows may be adjusted according to the conveyance speed of the first conveyance device 6, a detection speed of the inspection device 2, or the like. Therefore, a predetermined rule for conveying the tofu may vary depending on characteristics of the tofu as a target product. An inspection region of the inspection device 2 (that is, an image capturing region of the image capturing unit 3) is provided on a conveyance path of the first conveyance device 6.

The sorting and removing device 5 is configured such that the grip portion is movable in the upper-lower direction (Z axis) and in directions (X axis and Y axis) perpendicular to the conveyance direction of the products such that the product P′ can be taken out and conveyed on the conveyance path of the first conveyance device 6. Setting of an axial direction and an origin is not limited, and is omitted in the drawings. The first conveyance device 6 according to the present embodiment is formed of an endless belt, and the products are conveyed in the predetermined conveyance direction by continuously rotating the endless belt. A state of the products conveyed by the first conveyance device 6 is not particularly limited, and may be, for example, a state of only the products before packaging or a state in which the products are packaged. That is, inspection according to the present embodiment may be performed on the products before packaging or on the products after packaging. Alternatively, inspection may be performed both before and after packaging.

The second conveyance device 7 receives the plurality of products P conveyed from the first conveyance device 6 and conveys the products P in a predetermined conveyance direction. In the example of FIG. 1, the conveyance direction of the first conveyance device 6 and the conveyance direction of the second conveyance device 7 are perpendicular to each other, and a matrix array is changed to a single row array for conveyance. In a broad sense, devices such as conveyors connected behind the first conveyance device 6 in the conveyance direction may be collectively regarded as the second conveyance device 7. The conveyance speed of the first conveyance device 6 and a conveyance speed of the second conveyance device 7 may be the same or different. Each of the first conveyance device 6 and the second conveyance device 7 may be configured as a conveyor type (for example, a belt conveyor, a net conveyor made of a metal wire, a chocolate conveyor, a bar conveyor, a slat band chain, or the like), and is not particularly limited. Although not shown, the second conveyance device 7 may convey the products P (only non-defective products) in a stacked manner, may convey the products P in an inverted manner, or may convey the products P in an aligned manner. Thereafter, a conveyance device may be further provided, and an inspection device or a sorting and removing device may be further provided at an appropriate position. The conveyance device, the inspection device, or the sorting and removing device further provided in this case may have a configuration the same as that of the first conveyance device 6, the second conveyance device 7, the inspection device 2, or the sorting and removing device 5 described above, or may have a different configuration.

The product P′ determined as the defective product is conveyed from the defective product conveyance device 10 and stored in the storage device 8. The stored product P′ may be conveyed to a different place via the storage device 8, or may be removed manually. The product P′ determined as the defective product may be discarded, or may be used for another purpose (for example, reproduction of an intermediate product, or a processed product such as chopped fried tofu).

The production device 9 includes a continuous coagulation machine, a continuous molding machine, a continuous cutting machine, a continuous alignment machine, a continuous fryer, a continuous freezer, a continuous sterilizer, and the like. The production device 9 is a machine that continuously produces a plurality of products (here, tofu), and is installed upstream of the first conveyance device 6 in the conveyance direction. The products produced by the production device 9 are sequentially conveyed to the first conveyance device 6. Raw materials of the products are supplied to the production device 9 timely.

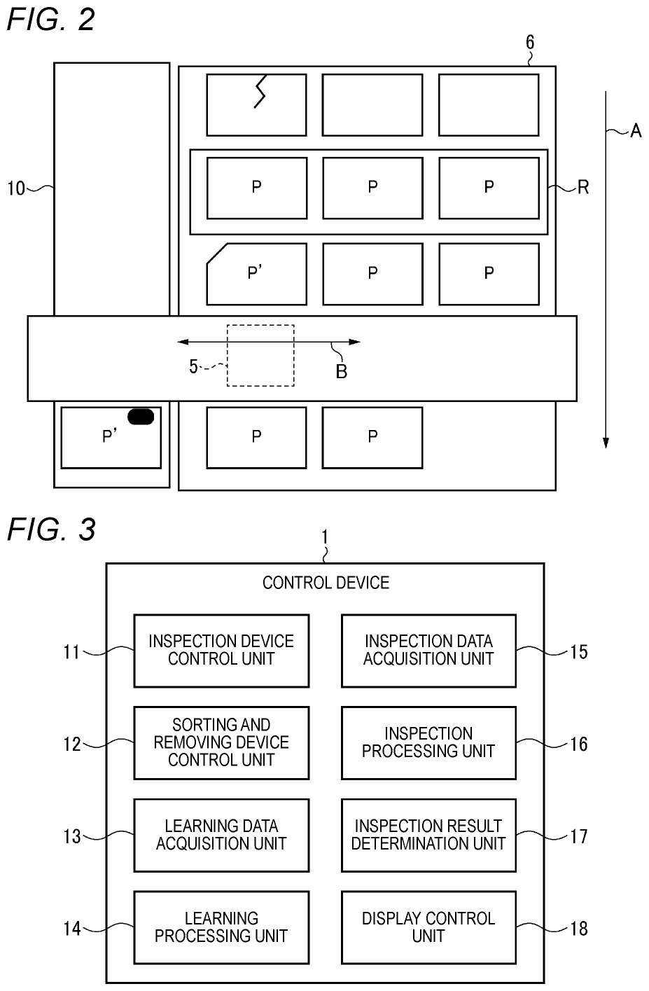

The defective product conveyance device 10 receives the product P′ determined as the defective product from the sorting and removing device 5, and conveys the product P′ toward the storage device 8. The defective product conveyance device 10 according to the present embodiment is formed of an endless belt, and the product P′ determined as the defective product is conveyed in a predetermined conveyance direction toward the storage device 8 by continuously rotating the endless belt. A conveyance speed of the defective product conveyance device 10 may be the same as or different from the conveyance speed of the first conveyance device 6. The defective product conveyance device 10 does not need to be continuously driven, and may be configured to be driven when a defective product is detected. The defective product conveyance device 10 may be configured as a conveyor type (for example, a belt conveyor, a net conveyor, a bar conveyor, a slat band chain, or the like), and is not particularly limited. FIG. 2 shows an example in which a conveyance direction of the defective product conveyance device 10 is the same as the conveyance direction of the first conveyance device 6, but the conveyance direction of the defective product conveyance device 10 is not limited thereto.

FIG. 2 is a view showing an inspection position by the inspection device 2 of the production system according to the present embodiment and an operation of the sorting and removing device 5. An arrow A shown in FIG. 2 indicates a conveyance direction of products by the first conveyance device 6. A region R indicates an image capturing range of the image capturing unit 3, and is also a region with which light is irradiate by the irradiation unit 4. Here shows an example in which the products are being conveyed in three rows. A result of inspection on the products indicates the product P determined as a non-defective product and the product P′ determined as a defective product. Examples of the defective product here include a product whose shape is chipped or cracked, a product in which foreign matter is detected on a surface, and the like. The sorting and removing device 5 is movable in a direction of an arrow B under control of the control device 1. Further, the sorting and removing device 5 is movable in an upper-lower direction as shown in FIG. 1. By such an operation, the sorting and removing device 5 moves to a position of the product P′ determined as the defective product, grips the product P′, and conveys the product P′ to a position of the defective product conveyance device 10.

FIG. 2 shows an example in which one sorting and removing device 5 is provided, but a plurality of sorting and removing devices 5 may be provided. In this case, each of the plurality of sorting and removing devices 5 may be configured to be independently movable in the direction of the arrow B (X-axis direction). When the plurality of sorting and removing devices 5 are provided, only some of the sorting and removing devices 5 may operate according to a conveyance speed of the first conveyance device 6, a generation rate of the product P′ determined as the defective product, and the like.

The sorting and removing device 5 may be configured to be movable in a direction the same as the conveyance direction of the first conveyance device 6 (a direction of the arrow A, Y-axis direction). In this case, an operable range is expanded even for one sorting and removing device 5. Further, the sorting and removing device 5 may be implemented by a high-speed robot such as a SCARA robot or a parallel link robot including multiple joints. The high-speed robot has, for example, an operation capacity of 40 CPM to 500 CPM (cycle per minute) in a range of an operation distance of 200 mm to 2,000 mm. The operation capacity of the high-speed robot is preferably 60 CPM to 300 CPM, and most preferably 100 CPM to 200 CPM. A high-speed serial link robot having such an operation capability may be used. Thereby, a drive range of the sorting and removing device 5 further widens in addition to a movement range in the direction of the arrow B in FIG. 2, and thus the sorting and removing device 5 can finely adjust a position when gripping the product P′ determined as the defective product. Further, these robots may be used as an alignment device for stacking non-defective products, a transfer device, or the like, and such a configuration makes it possible to reduce a plurality of workers and improve cost-effectiveness. For example, it is preferable that the product P′ determined as the defective product is simply removed by a drop at an end portion of the conveyance device, and the product P determined as the non-defective product is transferred and aligned as work by the robot.

FIG. 2 shows an example in which the defective product conveyance device 10 is disposed on one side of the first conveyance device 6, but the defective product conveyance devices 10 may be disposed on both sides. In this case, it may be controlled to which defective product conveyance device 10 the defective product P′ is conveyed according to an inspection result of the inspection device 2. For example, when A (non-defective product), B (for processed product), and C (defective product) are used as evaluation values in inspection, the operation of the sorting and removing device 5 may be controlled such that products having the evaluation values B and C are conveyed to different defective product conveyance devices 10. Alternatively, it may be provided with a conveyor (for example, channelizer or touchline selector) that first removes (for example, air reject) a product having an evaluation value C and then sorts products having evaluation values A and B. An order and a method of sorting and removing products are not limited to those described above, and other patterns and configurations may be used.

The example of FIG. 1 shows a configuration in which the product P′ determined as the defective product is removed by the sorting and removing device 5, but the present invention is not limited thereto. For example, according to a ratio of the product P determined as the non-defective product and the product P′ determined as the defective product, the product P determined as the non-defective product may be taken out from the conveyed products by an alignment device (not shown) and conveyed to a subsequent conveyance device to be aligned. At this time, the alignment device (not shown) may perform operations such as packing the products P in a box and aligning a predetermined number of products P (for example, ten products in a case of fried tofu) in a vertical direction or a horizontal direction such that the products P are stacked. Alternatively, the product P′ determined as the defective product may be removed using the sorting and removing device 5, and the product P determined as the non-defective product may be conveyed from the first conveyance device 6 to the second conveyance device 7 using a relay device (not shown). Alternatively, the sorting and removing device 5 may be configured to operate as an alignment device. In this case, a drive mechanism of the sorting and removing device 5 and a drive mechanism of the alignment device (a robot capable of high-speed operation such as a SCARA robot or a parallel link robot including a linear motion cylinder, an orthogonal cylinder including two or more orthogonal cylinders, and/or multiple joints, a high-speed serial link robot, a dual-arm robot, or the like) are unitized or shared, which saves space in a size of the production system compared to separate installation, and enables high-speed processing (at least 5,000 or more products/h, corresponding to 10,000 to 50,000 products/h). The SCARA robot is a mechanism in which a Z axis is defined in each of a plurality of rotation shafts, arms, and tip portions. All of the plurality of rotation shafts and arms are used for horizontal movement of robot tip portions. The robot tip portion is moved directly above a workpiece by an operation of the rotation shaft, and work is performed on the workpiece in the Z-axis direction of the robot tip portion. The parallel link robot is a mechanism in which a plurality of connection chains formed by links and joints are arranged in parallel between an output link and a base.

Alternatively, a conveyance device that conveys products at regular intervals may be configured such that a branch is provided on a conveyance path, and conveyance is switched such that the product P determined as the non-defective product and the product P′ determined as the defective product proceed to different paths for sorting. A sorting function of removing or sorting the products according to such a determination result may be achieved by providing a mechanism such as a flipper type, an up-out type, a drop-out type, an air jet type, a trip type, a carrier type, a pusher type, a chute type, a shuttle type, a channelizer type, or a touchline selector type on the conveyance path.

The example of FIG. 1 shows a configuration in which the products are conveyed, sorted, and the like by devices in the production system, but the present invention is not limited thereto. For example, manual work may be performed as a part of sorting. For example, a worker may be notified by the production system such that the worker can visually confirm the product P′ determined as the defective product, and the worker works to remove the product P′. Notification here may be performed, for example, by displaying an image of the product P′ determined as the defective product on a display device (not shown), or may be performed by illuminating the product P′ with light or the like on the conveyance device. At this time, the worker may confirm the product notified by the production system and then determine whether to actually remove the product.

[Device Configuration]

FIG. 3 is a block diagram showing an example of a functional configuration of the control device 1 according to the present embodiment. The control device 1 may be, for example, an information processing device such as a personal computer (PC). Each function shown in FIG. 3 may be achieved by a control unit (not shown) reading and executing a program for the function according to the present embodiment stored in a storage unit (not shown). The storage unit may include a random access memory (RAM), which is a volatile storage area, a read only memory (ROM), a hard disk drive (HDD), and the like, which are non-volatile storage areas. A central processing unit (CPU), a graphical processing unit (GPU), general-purpose computing on graphics processing units (GPGPU), or the like may be used as the control unit.

The control device 1 includes an inspection device control unit 11, a sorting and removing device control unit 12, a learning data acquisition unit 13, a learning processing unit 14, an inspection data acquisition unit 15, an inspection processing unit 16, an inspection result determination unit 17, and a display control unit 18.

The inspection device control unit 11 controls the inspection device 2 to control an image capturing timing and image capturing setting of the image capturing unit 3 and an irradiation timing and irradiation setting of the irradiation unit 4. The sorting and removing device control unit 12 controls the sorting and removing device 5 to remove the product P′ on the conveyance path of the first conveyance device 6 based on a determination result of whether the product is a non-defective product or a defective product.

The learning data acquisition unit 13 acquires learning data used in learning processing executed by the learning processing unit 14. Details of the learning data will be described later, and the learning data may be input based on, for example, an operation of an administrator of the production system. The learning processing unit 14 executes the learning processing using the acquired learning data to generate a learned model. Details of the learning processing according to the present embodiment will be described later. The inspection data acquisition unit 15 acquires an image captured by the inspection device 2 as inspection data. The inspection processing unit 16 applies the learned model generated by the learning processing unit 14 to the inspection data acquired by the inspection data acquisition unit 15 to inspect a product whose image is captured as the inspection data.

The inspection result determination unit 17 determines a control content for the sorting and removing device control unit 12 based on an inspection result of the inspection processing unit 16. Then, the inspection result determination unit 17 outputs a signal based on the determined control content to the sorting and removing device control unit 12. The display control unit 18 controls a display screen (not shown) displayed on a display unit (not shown) based on a determination result of the inspection result determination unit 17. The display screen (not shown) may display, for example, a statistical value of a product determined as a defective product based on the determination result of the inspection result determination unit 17, an actual image of the product P′ determined as the defective product, and the like. It is preferable to perform setting adjustment on various parameters such as an image capturing condition, a learning condition, an inspection condition, and a determination threshold value, and setting adjustment on control parameters for a conveyance device, a sorting and removing device, and the like by using a touch panel type display unit (not shown).

[Learning Processing]

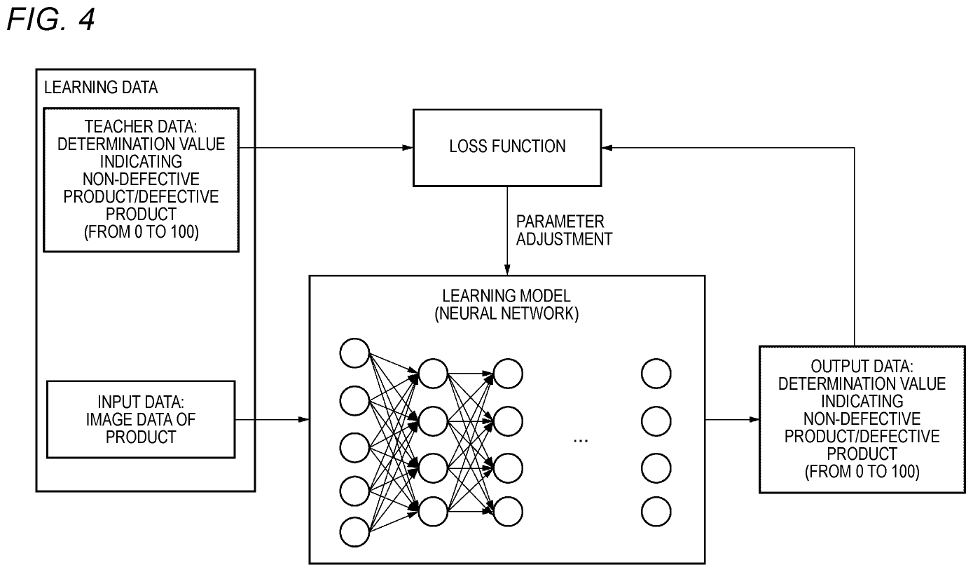

In the present embodiment, a method of deep learning using a neural network among machine learning is used as a learning method, and supervised learning will be described as an example. Amore specific method (algorithm) of deep learning is not particularly limited, and for example, a known method such as a convolutional neural network (CNN) may be used. FIG. 4 is a schematic diagram showing a concept of the learning processing according to the present embodiment. The learning data used in the present embodiment includes a pair of image data of a product as input data and an evaluation value obtained by evaluation of humans (a producer of tofu) on the product as teacher data. Here, values from 0 to 100 are set as evaluation values, and the larger the number is, the higher the evaluation is. A granularity of the evaluation values is not limited thereto, and for example, the evaluation may be performed in three stages A, B, and C, or by two values of non-defective product/defective product, or may be performed by an evaluation value for each of a plurality of defective product items. A method for normalizing the evaluation value for the product is not limited to the above, and other classifications may be used. The machine learning other than the neural network is not particularly limited as long as it is machine learning in a broad sense such as a decision tree, a support vector machine, a random forest, and a regression analysis (multivariate analysis, multiple regression analysis).

When input data prepared as learning data (here, image data of tofu) is input to a learning model, an evaluation value is output as output data for the input data. Next, an error is derived by a loss function using the output data and teacher data prepared as learning data (here, the evaluation value for the tofu indicated by the image data). Then, each parameter in the learning model is adjusted so as to reduce the error. For example, an error back propagation method or the like may be used to adjust the parameter. In this way, a learned model is generated by repeatedly performing learning using a plurality of learning data.

The learning model used in the present embodiment may have a configuration in which learning is performed using learning data from a state in which learning is not performed at all. However, in order to obtain an optimum learned model, a large amount of learning data is required, and a processing load due to repetition of learning processing using the learning data is also heavy. Therefore, a user (for example, the producer of tofu) may be burdened by updating the learned model with new learning data. Therefore, for a purpose of identifying an image, a learning model in which a certain degree of learning has progressed or parameters thereof (connection between neurons, weight, and the like) may be used for a huge number of types of image data and a huge number of image data. A learning model in which learning processing by deep learning has progressed in view of image recognition includes a part that can be commonly used even when a target of image recognition is different. In a learning model reinforced by the image recognition, adjustment of parameters in convolution layers and pooling layers including several to several tens even to several hundreds of layers has already progressed. In the present embodiment, for example, a so-called transfer learned learning model may be used in which values of parameters of most of convolutional layers from an input side to an intermediate layer are fixed without being changed, and new learning data (for example, an image of tofu) is learned for several layers (for example, only the last one to several layers) on an output side to adjust parameters. When such a transfer learning model is used, the number of new learning data is relatively small, and there is an advantage that it is possible to easily update the learned model while reducing a processing load of relearning.

The learning processing does not necessarily have to be executed by the control device 1. For example, the production system may be configured to provide learning data to a learning server (not shown) provided outside the production system and execute learning processing on a server side. Then, the server may provide a learned model to the control device 1 if necessary. Such a learning server may be located on a network (not shown) such as the Internet, and the server and the control device 1 are communicably connected to each other.

[Processing Flow]

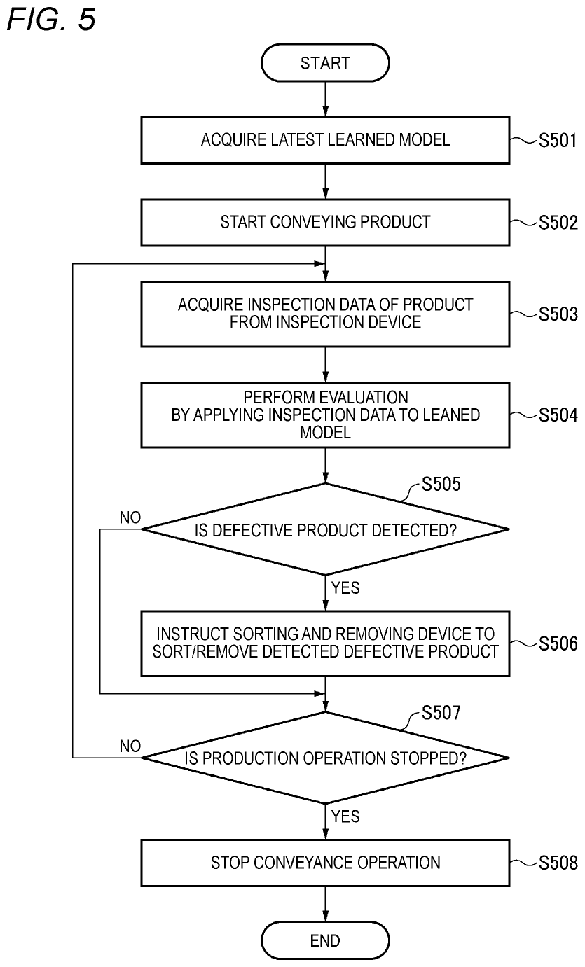

Hereinafter, a processing flow of the control device 1 according to the present embodiment will be described with reference to FIG. 5. Processing to be described below is implemented, for example, by a CPU (not shown) or a GPU (not shown) included in the control device 1 reading and executing a program stored in a storage device (not shown) such as an HDD. The following processing may be continuously executed while the production system is operating.

In S501, the control device 1 acquires the latest or optimum learned model among learned models generated by executing learning processing. The learned model is updated each time the learning processing is timely repeated for a learning model. Therefore, the control device 1 acquires the latest learned model when the present processing is started, and uses the latest learned model in the subsequent processing.

In S502, the control device 1 causes the inspection device 2 to start capturing an image on a conveyance path of the first conveyance device 6. Further, the control device 1 operates the first conveyance device 6, the second conveyance device 7, and the defective product conveyance device 10 to start conveying a product supplied from the production device 9.

In S503, the control device 1 acquires inspection data (an image of the product) transmitted timely from the inspection device 2 that captures an image of the product by using a signal of the detection sensor T that detects the product as a trigger, in accordance with conveyance of the product by the first conveyance device 6. When a conveyance interval between conveyed products or a conveyance position where each product is arranged is defined in advance on the conveyance path, the image of the product may be separately captured based on the position. Alternatively, when the inspection data transmitted timely from the inspection device 2 is a moving image, frames may be extracted from the moving image at predetermined intervals, and the frame may be treated as image data. Captured raw image data may be used directly as the image of the product. The raw image data may be used as learning data by being appropriately subjected to data cleansing processing (excluding data whose characteristics are difficult for humans to view) or padding processing (a plurality of images with increased noise or a plurality of images with adjusted brightness are also added to the learning data). Processed image data obtained by applying certain image processing to the raw image data may be used as the learning data. The certain image processing may include, for example, various types of filter processing such as contour processing (edge processing), position correction processing (rotation, center position movement, and the like), brightness correction, shading correction, contrast conversion, convolution processing, difference (primary differential, secondary differential), binarization, noise removal (smoothing), and the like. The preprocessing and data processing have advantages such as reduction and adjustment of the number of learning data, improvement of learning efficiency, reduction of disturbance influence, and the like.

In S504, the control device 1 inputs the inspection data (the image data of the product) acquired in S503 to the learned model. Thereby, an evaluation value of the product indicated by the inspection data is output as output data. It is determined whether the product to be inspected is a non-defective product or a defective product according to the evaluation value.

In S505, the control device 1 determines whether the product to be inspected is a defective product based on the evaluation value obtained in S504. When the defective product is detected (YES in S505), the processing of the control device 1 proceeds to S506. On the other hand, when the defective product is not detected (NO in S505), the processing of the control device 1 proceeds to S507.

For example, in a configuration in which the evaluation value is evaluated by 0 to 100, a threshold value for the evaluation value may be set, and it may be determined whether the product to be inspected is the non-defective product or the defective product by comparing the threshold value with the evaluation value output from the learned model. In this case, the threshold value serving as a criterion for determining whether the product is the non-defective product or the defective product may be set by an administrator of the production system (for example, a producer of tofu) via a setting screen (not shown) at any timing. As described above, an appearance and a shape of the tofu to be inspected in the present embodiment may change depending on various factors. In consideration of such a change, the administrator may be able to control the threshold value for the output data obtained by the learned model. In a configuration in which the evaluation value is evaluated by A, B, and C, the evaluation values A and B may be treated as non-defective products, and the evaluation value C may be treated as a defective product.

In S506, the control device 1 controls the sorting and removing device 5 by instructing the sorting and removing device 5 to sort and remove the product detected as the defective product in S505. At this time, in order to sort and remove the product P′ detected as the defective product, the control device 1 specifies a position of the product P′ to be removed based on the inspection data acquired from the inspection device 2, a conveyance speed of the first conveyance device 6, and the like. As a method for specifying the position of the product, a known method may be used, and detailed description thereof will be omitted here. The sorting and removing device 5 conveys the product P′ to be removed to the defective product conveyance device 10 based on an instruction from the control device 1.

Even when a quality of the appearance of the tofu does not satisfy a certain criterion, the tofu may be used as a raw material for another processed product. Therefore, for example, in a configuration in which the evaluation value is evaluated by A, B, and C, the evaluation value A may be treated as a non-defective product, the evaluation value B may be treated as a processing target, and the evaluation value C may be treated as a defective product. In this case, the control device 1 may control the sorting and removing device 5 to convey the product determined to have the evaluation value B to a position of a conveyance device for the processed product. Examples of the processed product to be diverted include producing chopped fried tofu from fried tofu, producing ganmodoki from tofu, and mixing finely pasted liquid (reproduced liquid) with a soybean juice or soymilk for reuse.

In S507, the control device 1 determines whether a production operation is stopped. Stop of the production operation may be determined in response to detection that supply of the product from the production device 9 located upstream of the first conveyance device 6 is stopped, or may be determined based on a notification from the production device 9. When the production operation is stopped (YES in S507), the processing of the control device 1 proceeds to S508. On the other hand, when the production operation is not stopped (NO in S507), the processing of the control device 1 returns to S503, and the corresponding processing is repeated.

In S508, the control device 1 stops a conveyance operation of the first conveyance device 6. In addition, the control device 1 may stop conveyance operations of the second conveyance device 7 and the defective product conveyance device 10, or may stop the conveyance operations after a certain conveyance is completed. The control device 1 may perform an operation of executing initialization processing on the learned model acquired in S501. Then, the present processing flow is ended.

The inspection data acquired in S503 may be stored for use in future learning processing. In this case, image processing may be executed such that the acquired inspection data becomes image data for learning.

[Display Processing]

In the present embodiment, when an image of the product P′ determined as the defective product is displayed on a display unit (not shown) as a result of inspection on the tofu product, a basis (defective portion) for determination as the defective product may be displayed. In learning of the neural network as described above, there is a visualization method such as GRAD-CAM or Guided Grad-CAM. By using such a method, when a product to be inspected is determined as a defective product, a focused region may be specified as a basis for determination, and the region may be visualized and displayed. Even in a case of a product determined as a non-defective product, when an evaluation value therefor is close to an evaluation value for determination as the defective product, a focused region may be specified and displayed using the above-described method.

As described above, according to the present embodiment, it is possible to improve a production capacity while reducing a manual load during production of tofu. It is possible to save human space in the production system by reducing a load of manual inspection performed according to characteristics of the tofu. Since it is possible to inspect a plurality of products in parallel on a conveyance path, it is possible to improve production efficiency. With a configuration in which inspection and removal of the defective product can be performed while the plurality of products are conveyed in parallel, it is possible to shorten a path length of a conveyance path of the entire production system without lowering inspection accuracy of the products.

### Second Embodiment

A configuration in which the inspection device 2 is fixed and an inspection range (image capturing position) is fixed has been described in the first embodiment. A configuration in which an inspection range of the inspection device 2 can be changed will be described in a second embodiment of the present invention. Description of a configuration the same as that of the first embodiment will be omitted, and description will be made focusing on a difference.

[Configuration Overview]

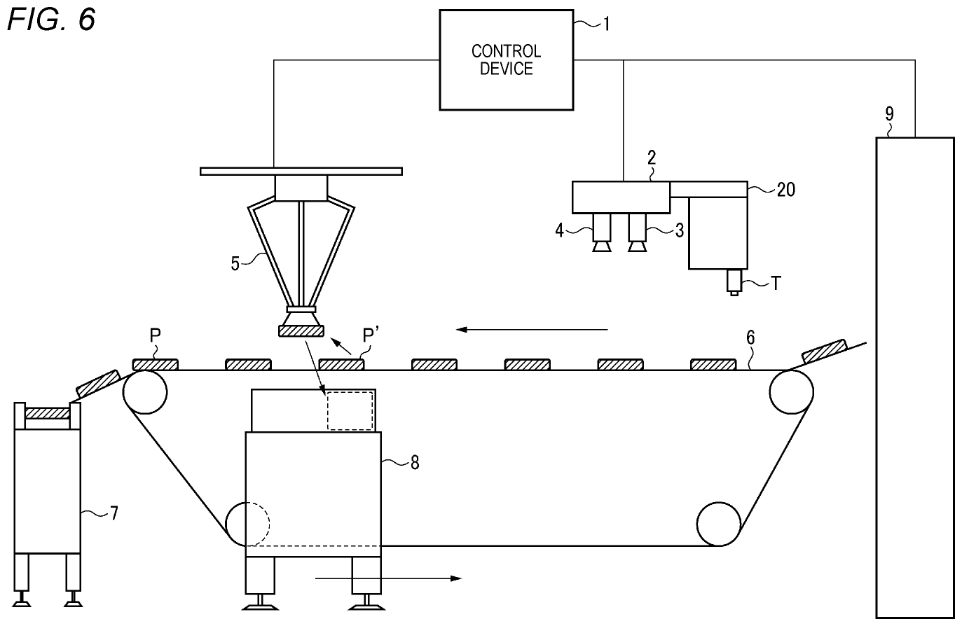

FIG. 6 is a schematic configuration view showing an overall configuration of a tofu production system (hereinafter, simply referred to as a “production system”) according to the present embodiment. The production system according to the present embodiment includes the control device 1, the inspection device 2, the sorting and removing device 5, the first conveyance device 6, the second conveyance device 7, the storage device 8, and the production device 9.

The control device 1 controls an image capturing operation of the inspection device 2. The control device 1 also controls an operation of the sorting and removing device 5 based on an image acquired by the inspection device 2. The inspection device 2 includes the image capturing unit 3, the irradiation unit 4, and a drive mechanism 20. A position of the inspection device 2 is adjusted by operating an activation mechanism based on an instruction from the control device 1, whereby an image capturing range and a product to be image-captured are specified. Based on an instruction from the control device 1, the sorting and removing device 5 takes out the product P′ specified as a defective product from products being conveyed by the first conveyance device 6, and conveys the product P′ to the storage device 8.

FIG. 6 shows an example of a parallel link robot as the sorting and removing device 5, but a serial link robot may be used. The sorting and removing device 5 may include a dual-arm robot, a linear motion cylinder, an orthogonal cylinder including two or more orthogonal cylinders, or the like. The sorting and removing device 5 is configured to be operable in any of three axial directions (X axis, Y axis, and Z axis) such that the product P can be transferred and aligned or the product P′ can be taken out on a conveyance path of the first conveyance device 6. Setting of an axial direction and an origin is not limited, and is omitted in the drawings.

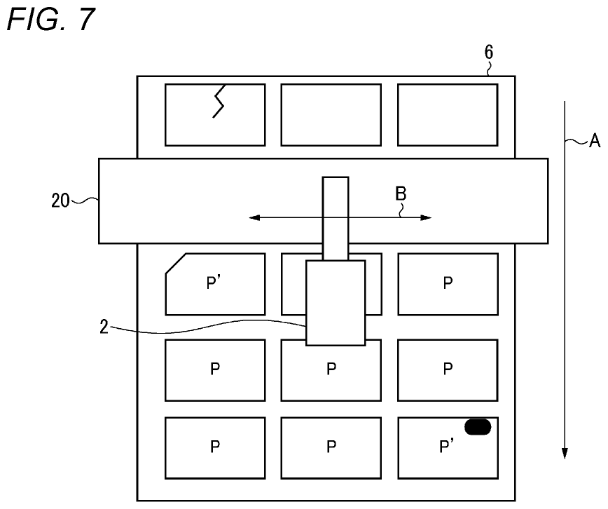

FIG. 7 is a view showing position control when inspection is performed by the inspection device 2 according to the present embodiment. An arrow A shown in FIG. 7 indicates a conveyance direction of the products by the first conveyance device 6. An arrow B indicates a movement direction of the inspection device 2, and is a direction perpendicular to a direction of the arrow A. With this configuration, it is possible to change an image capturing range of the image capturing unit 3 included in the inspection device 2 to any range. Since the image capturing range can be switched by movement of the inspection device, it is possible to reduce a size of a sensor such as a light receiving element of the image capturing unit 3, and to reduce a size of the image capturing unit 3 and the number thereof.

An example of FIG. 7 shows a configuration in which a position of the inspection device 2 can be adjusted along a direction of the arrow B, but the present invention is not limited thereto. For example, the drive mechanism 20 may be configured to be capable of further adjusting the position of the inspection device 2 along the direction of the arrow A. The drive mechanism 20 may be configured to be capable of further adjusting the position of the inspection device 2 along a direction (upper-lower direction) that is different from the direction of the arrow B and is perpendicular to the direction of the arrow A. In this case, since the position of the inspection device 2 can be simultaneously moved in a plurality of directions, it is possible to efficiently perform the inspection according to a size and a conveyance state of the product by adjusting the position in any track such as a zigzag shape. As another configuration, the inspection device 2 may be configured to include a SCARA robot including multiple joints. Thereby, a drive range of the inspection device 2 (image capturing unit 3) further widens in addition to a movement range in the direction of arrow B in FIG. 7, and thus the inspection device 2 can finely adjust an image capturing position of the product.

As described above, according to the present embodiment, the product (tofu) can be inspected while the inspection device is moved to any position, in addition to effects of the first embodiment.

### OTHER EMBODIMENTS

In the above embodiment, the example of supervised machine learning has been described as a method used for inspection, but the present invention is not limited thereto. For example, a learned model may be generated by unsupervised machine learning such as an auto-encoder. In this case, the learned model is generated by performing learning using image data of a non-defective product among products as learning data. Then, based on a difference between an image of a product input to the learned model and an image of a product output from the learned model, it may be determined whether the product indicated by the input image is a non-defective product or a defective product.

In the above embodiment, the inspection device 2 is configured to capture an image of only one surface (upper surface in FIG. 1) of the product for inspection as shown in FIG. 1. However, the present invention is not limited thereto, and, for example, an image of a back surface or a side surface may be acquired and inspected in addition to a front surface. In this case, a plurality of inspection devices 2 may be provided, and images of a product may be captured from a plurality of directions by image capturing unit s (cameras) included in the plurality of respective inspection devices 2. For example, a first image capturing unit (not shown) may be installed so as to capture an image of a front surface of the product from a first direction, and a second image capturing unit (not shown) may be installed so as to capture an image of a back surface of the product from a second direction. Alternatively, a configuration (inversion mechanism) that inverts a product on a conveyance path may be provided in the first conveyance device 6, and images of the product may be captured before and after inversion, and inspection may be performed using the captured images. At this time, the inspection may be performed using different learned models for a front surface, a back surface, and a side surface of the product. That is, learning is performed using different learning data of the front surface, the back surface, and the side surface according to a type, a packaging state, and the like of the product conveyed by the first conveyance device 6, and thus the learned models corresponding to respective surfaces are generated. Then, the inspection may be performed using the learned models corresponding to image capturing directions.

Inspection is not limited to inspection using a learning model. For example, a product may be inspected alone or in combination by pattern matching with image data indicating a non-defective product prepared in advance. In addition, inspection for preferentially recognizing a shape may also be performed by using data in a three-dimensional direction acquired by using a displacement sensor, a distance sensor, or the like according to related art in combination. Further, the inspection device may be used in combination with other inspection devices such as an image inspection device, an X-ray detector, a metal detector, and a weight inspection device according to related art.

In the above embodiment, the irradiation unit 4 irradiates the product with light from a direction the same as that of the image capturing unit 3 (camera) as shown in FIG. 1. However, the present invention is not limited to this configuration, and for example, the image capturing unit 3 and the irradiation unit 4 may have different positions and orientations facing the product. In a case of this configuration, for example, the irradiation unit 4 may include a light source that irradiates the product with a wavelength of X-rays, ultraviolet rays, or infrared rays in addition to visible light, and the image capturing unit 3 may acquire image data based on transmitted light, transmitted reflected light, or transmitted scattered light of the product. Then, the product may be inspected based on internal information on the product indicated by the image data.

As described above, the following matters are disclosed in the present specification.

(1) A tofu production system including:

a production device configured to continuously produce tofu;

a conveyance device configured to arrange the tofu produced by the production device according to a predetermined rule corresponding to the tofu and convey the tofu;

a tofu inspection device configured to inspect the tofu on the conveyance device; and

a sorting and removing device configured to sort or remove a defective product in the tofu being conveyed by the conveyance device based on an inspection result of the tofu inspection device.

According to this configuration, it is possible to improve a production capacity while reducing a manual load during production of the tofu. It is possible to save human space in the production system by reducing a load of manual inspection performed according to characteristics of the tofu. Since it is possible to inspect a plurality of products in parallel on a conveyance path, it is possible to improve production efficiency. With a configuration in which inspection and sorting or removal of the defective product can be performed while the plurality of products are conveyed in parallel, it is possible to shorten a path length of a conveyance path of the entire manufacturing system without lowering inspection accuracy of the products.

(2) The tofu production system according to (1),

wherein the conveyance device includes: a first conveyance device configured to arrange the tofu produced by the production device in a plurality of rows and convey the tofu; and a second conveyance device located downstream of the first conveyance device in a conveyance direction, the second conveyance device being configured to arrange the tofu conveyed from the first conveyance device in a single row and convey the tofu in a direction perpendicular to the conveyance direction of the first conveyance device.

According to this configuration, it is possible to inspect and convey the tofu by combining conveyance devices having different conveyance methods.

(3) The tofu production system according to (2),

wherein the tofu inspection device inspects the tofu on at least one of the first conveyance device and the second conveyance device, and

wherein the sorting and removing device sorts or removes the defective product in the tofu being conveyed by the first conveyance device or the second conveyance device based on the inspection result of the tofu inspection device.

According to this configuration, it is possible to sort and remove the defective product during conveyance while inspecting the tofu by combining the conveyance devices having different conveyance methods.

(4) The tofu production system according to any one of (1) to (3),

wherein the sorting and removing device includes a high-speed robot (a SCARA robot, a parallel link robot, or a high-speed serial link robot) including a linear motion cylinder or multiple joints, configured to adjust a position of a sorting operation or a removing operation.

According to this configuration, a drive range of the sorting and removing device that sorts and removes the tofu determined as the defective product can be designed to be any range on the conveyance path of the conveyance device, whereby the sorting and removing device can be driven.

(5) The tofu production system according to any one of (1) to (4),

wherein the tofu inspection device includes a SCARA robot including a linear motion cylinder or multiple joints, configured to adjust a position of an inspection operation.

According to this configuration, an image capturing range of the inspection device that inspects the tofu can be designed to be any range on the conveyance path of the conveyance device, and image capture can be performed at a certain position.

(6) The tofu production system according to any one of (1) to (5), further including:

an alignment device configured to align a non-defective product in the tofu being conveyed by the conveyance device according to a predetermined rule based on an inspection result of the tofu inspection device.

According to this configuration, the tofu determined as the non-defective product, which is being conveyed by the conveyance device, can be aligned according to the predetermined rule.

(7) The tofu production system according to (6),

wherein the alignment device includes a high-speed robot (a SCARA robot, a parallel link robot, or a high-speed serial link robot) including a linear motion cylinder or multiple joints, configured to adjust a position of an alignment operation.

According to this configuration, a drive range of the alignment device that aligns the tofu determined as the non-defective product can be designed to be any range on the conveyance path of the conveyance device, whereby the alignment device can be driven.

(8) The tofu production system according to (6) or (7),

wherein the removing device also serves as the alignment device.

According to this configuration, while having functions of the alignment device and the removing device, it is possible to realize space saving as compared with a case where the alignment device and the rejection device are separately provided.

(9) The tofu production system according to any one of (1) to (8),

wherein the conveyance device includes an inversion mechanism configured to invert the tofu being conveyed, and

wherein the tofu inspection device inspects the tofu using images captured before and after inversion performed by the inversion mechanism.

According to this configuration, by performing inspection on surfaces of the tofu before and after the inversion, it is possible to perform the inspection with higher accuracy.

(10) The tofu production system according to any one of (1) to (9), further including:

display means for displaying a captured image indicating the tofu determined as the defective product based on the inspection result of the tofu inspection device.

According to this configuration, a producer of the tofu can confirm the image of the actual tofu determined as the defective product.

(11) The tofu production system according to any one of (1) to (10),

wherein the tofu inspection device includes: an image capturing unit configured to capture an image of the tofu to be inspected; and inspection means for determining a quality of the tofu indicated by a captured image using an evaluation value as output data obtained by inputting the captured image of the tofu captured by the image capturing unit as input data with respect to a learned model for determining a quality of tofu indicated by input data, the learned model being generated by performing machine learning using learning data including a captured image of tofu.

According to this configuration, it is possible to reduce a load of manual inspection while considering the characteristics of the tofu during production.

(12) The tofu production system according to (11),

wherein the learned model is generated by deep learning using a neural network.

According to this configuration, it is possible to inspect the tofu using the learned model obtained by a learning method based on the deep learning using the neural network and reduce the load of manual inspection.

(13) The tofu production system according to any one of (1) to (10),

wherein inspection of the tofu by the tofu inspection device is implemented by pattern matching.

According to this configuration, it is possible to inspect the tofu by pattern matching and reduce the load of manual inspection.

(14) The tofu production system according to any one of (1) to (13),

wherein the tofu is any one of packaged silken tofu, silken tofu, cotton tofu, grilled tofu, dried-frozen tofu, deep-fried tofu, a deep-fried tofu pouch, thin deep-fried tofu, thick deep-fried tofu, a tofu cutlet, and a deep-fried tofu burger.

According to this configuration, the tofu can be produced corresponding to a specific type of product.

Although various embodiments have been described above with reference to the drawings, it is needless to say that the present invention is not limited to these examples. It is apparent that those skilled in the art can conceive of various modifications and alterations within the scope of the claims, and it is understood that such modifications and alterations naturally fall within the technical scope of the present invention. Components in the embodiments described above may be combined within a range not departing from the spirit of the present invention.

The present application is based on a Japanese patent application filed on Apr. 30, 2020 (Japanese Patent Application No. 2020-080297) and a Japanese patent application filed on Nov. 18, 2020 (Japanese Patent Application No. 2020-191602), and the contents thereof are incorporated herein as reference.

### REFERENCE SIGNS LIST

1: Control Device
2: Inspection Device
3: Image Capturing Unit
4: Irradiation Unit
5: Sorting and Removing Device
6: First Conveyance Device
7: Second Conveyance Device
8: Storage Device
9: Production Device
10: Defective Product Conveyance Device
T: Detection Sensor
P: Non-Defective Product
P′: Defective product
11: Inspection Device Control Unit
12: Sorting and Removing Device Control Unit
13: Learning Data Acquisition Unit
14: Learning Processing Unit
15: Inspection Data Acquisition Unit
16: Inspection Processing Unit
17: Inspection Result Determination Unit
18: Display Control Unit

1. A tofu production system comprising:
a production device configured to continuously produce tofu;
a conveyance device configured to arrange the tofu produced by the production device according to a predetermined rule corresponding to the tofu and convey the tofu;
a tofu inspection device configured to inspect the tofu on the conveyance device; and
a sorting and removing device configured to sort or remove a defective product in the tofu being conveyed by the conveyance device based on an inspection result of the tofu inspection device.

2. The tofu production system according to claim 1,
wherein the conveyance device comprises:
a first conveyance device configured to arrange the tofu produced by the production device in a plurality of rows and convey the tofu; and
a second conveyance device located downstream of the first conveyance device in a conveyance direction, the second conveyance device being configured to arrange the tofu conveyed from the first conveyance device in a single row and convey the tofu in a direction perpendicular to the conveyance direction of the first conveyance device.

3. The tofu production system according to claim 2,
wherein the tofu inspection device inspects the tofu on at least one of the first conveyance device and the second conveyance device, and
wherein the sorting and removing device sorts or removes the defective product in the tofu being conveyed by the first conveyance device or the second conveyance device based on the inspection result of the tofu inspection device.

4. The tofu production system according to claim 1,
wherein the sorting and removing device comprises a high-speed robot comprising a linear motion cylinder or multiple joints, configured to adjust a position of a sorting operation or a removing operation.

5. The tofu production system according to claim 1,
wherein the tofu inspection device comprises a SCARA robot comprising a linear motion cylinder or multiple joints, configured to adjust a position of an inspection operation.

6. The tofu production system according to claim 1, further comprising:
an alignment device configured to align a non-defective product in the tofu being conveyed by the conveyance device according to a predetermined rule based on the inspection result of the tofu inspection device.

7. The tofu production system according to claim 6,
wherein the alignment device comprises a high-speed robot comprising a linear motion cylinder or multiple joints, configured to adjust a position of an alignment operation.

8. The tofu production system according to claim 6,
wherein the sorting and removing device also serves as the alignment device.

9. The tofu production system according to claim 1,
wherein the conveyance device comprises an inversion mechanism configured to invert the tofu being conveyed, and
wherein the tofu inspection device inspects the tofu using images captured before and after inversion performed by the inversion mechanism.

10. The tofu production system according to claim 1, further comprising:
a display device configured to display a captured image indicating the tofu determined as the defective product based on the inspection result of the tofu inspection device.

11. The tofu production system according to claim 1,
wherein the tofu inspection device comprises:
an image capturing device configured to capture an image of the tofu to be inspected;
a processor; and
a memory storing instructions that, when executed by the processor, cause a computer to perform operations comprising determining a quality of the tofu indicated by a captured image using an evaluation value as output data obtained by inputting the captured image of the tofu captured by the image capturing device as input data with respect to a learned model for determining a quality of tofu indicated by input data, the learned model being generated by performing machine learning using learning data including a captured image of tofu.

12. The tofu production system according to claim 11,
wherein the learned model is generated by deep learning using a neural network.

13. The tofu production system according to claim 1,
wherein inspection of the tofu by the tofu inspection device is implemented by pattern matching.

14. The tofu production system according to claim 1,
wherein the tofu is any one of packaged silken tofu, silken tofu, cotton tofu, grilled tofu, dried-frozen tofu, deep-fried tofu, a deep-fried tofu pouch, thin deep-fried tofu, thick deep-fried tofu, a fried cutlet, and a deep-fried tofu burger.

15. The tofu production system according to claim 1,
wherein the tofu inspection device is used in combination with a displacement sensor or a distance sensor using three-dimensional data, or an image inspection device, an X-ray detector, a metal detector, and a weight inspection device.

16. A tofu production system comprising:
a production device configured to continuously produce tofu;
a conveyance device configured to arrange the tofu produced by the production device according to a predetermined rule corresponding to the tofu and convey the tofu;
a tofu inspection device configured to inspect the tofu on the conveyance device; and
a sorting and removing device configured to align or remove the tofu being conveyed according to the predetermined rule by the conveyance device based on an inspection result of the tofu inspection device,
wherein the sorting and removing device comprises a robot comprising a linear motion cylinder or multiple joints, and
wherein in the predetermined rule, the number of rows or arrangement are adjusted according to a relationship between a size of the tofu produced by the production device and a width of the conveyance device.

17. The tofu production system according to claim 16,
wherein the sorting and removing device comprises a robot comprising multiple joints, and
wherein the robot is any one of a SCARA robot, a parallel link robot, and a serial link robot.

18. The tofu production system according to claim 16,
wherein the robot has an operation capacity of 40 CPM to 500 CPM in a range of an operation distance of 200 mm to 2000 mm, where CPM represents cycle per minute.

19. The tofu production system according to claim 16,
wherein the sorting and removing device also serves as an alignment device.

20. A tofu production system comprising:
a production device configured to continuously produce tofu;
a conveyance device configured to arrange the tofu produced by the production device according to a predetermined rule corresponding to the tofu and convey the tofu;
a tofu inspection device configured to inspect the tofu on the conveyance device; and
a sorting and removing device configured to align or remove the tofu being conveyed according to the predetermined rule by the conveyance device based on an inspection result of the tofu inspection device,
wherein the conveyance device arranges the tofu produced by the production device such that cakes of the tofu are arranged in a matrix or in a staggered manner or such that the cakes of the tofu are randomly arranged so as not to overlap with one another, and convey the tofu,
wherein in the predetermined rule, the number of rows or arrangement are adjusted according to a relationship between a size of the tofu produced by the production device and a width of the conveyance device, and
wherein the sorting and removing device picks up tofu determined das a non-defective product in the inspection result and align the tofu on the conveying device.
